(19) United States
(12) Patent Application Publication
(10) Pub. No.: US 2026/0130359 A1
(43) Pub. Date: May 14, 2026

(54) MOTORIZED SCARECROW

(71) Applicant: Tarell Gipson, Saginaw, MI (US)

(72) Inventor: Tarell Gipson, Saginaw, MI (US)

(21) Appl. No.: 18/946,073

(22) Filed: Nov. 13, 2024

(51) Int. Cl. A01M 29/10; A01M 29/16

(52) U.S. Cl. CPC A01M 29/06; A01M 29/10; A01M 29/16

(57) ABSTRACT

A motorized scarecrow includes a post, a motor positioned in the post, a body, a motion sensor system, a microprocessor, and a battery. The post includes a base portion and a support portion. The motor rotates the support portion with respect to the base portion. The body is mounted on the support portion. The body represents a human being. The motion sensor system is designed to detect motion and a location of a being. The microprocessor is connected to the motor and the motion sensor system. The microprocessor is designed to activate the motor upon detection movement of the being by the motion sensor system to rotate the support portion of the post. The microprocessor is designed to deactivate the motor upon the body is oriented with a front portion of the body facing toward the detected location of the being.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to scarecrows and more particularly pertains to a new motorized scarecrow for enhanced frightening of trespassing humans and animals. Motion sensors to detect the movement of a being, and the motorized scarecrow moves in relation to the being to better frighten the being than would be done by a static unit.

### (2) Description of Related Art including information disclosed under 37 CFR 1.97 and 1.98

The prior art relates to scarecrows. The prior art, as best understood, does not disclose a motorized scarecrow that includes a post, a motor positioned in the post, a body, a motion sensor system, a microprocessor, and a battery, wherein the microprocessor is designed to activate the motor upon detection movement of the being by the motion sensor system to rotate the support portion of the post, then deactivate the motor when the body is oriented with a front portion of the body facing toward the detected location of the being.

### BRIEF SUMMARY OF THE INVENTION

An embodiment of the disclosure meets the needs presented above in a motorized scarecrow generally comprising a post, a motor positioned in the post, a body, a motion sensor system, a microprocessor, and a battery. The post includes a base portion and a support portion that is rotatable with respect to the base portion. The motor is connected to the support portion to rotate the support portion with respect to the base portion. The body is mounted on the support portion of the post. The body includes a head portion and a shoulder portion designed to represent a human being. The motion sensor system is attached to the body. The motion sensor system is designed to detect motion and a location of a being. The microprocessor is positioned in the body. The microprocessor is connected to the motor and the motion sensor system. The microprocessor is designed to activate the motor upon detection movement of the being by the motion sensor system to rotate the support portion of the post. The microprocessor is designed to deactivate the motor upon the body is oriented with a front portion of the body facing toward the detected location of the being. The battery is positioned in the body. The battery is connected to the motor, the motion sensor system, and the microprocessor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a motorized scarecrow according to an embodiment of the disclosure.

FIG. 2 is a side view of an embodiment of the disclosure.

FIG. 3 is a back view of an embodiment of the disclosure.

FIG. 4 is a close-up view of a portion of an embodiment of the disclosure.

FIG. 5 is a front view of an embodiment of the disclosure in use.

FIG. 6 is a block diagram showing the relationship of components of an embodiment of the disclosure.

### DETAILED DESCRIPTION OF THE INVENTION

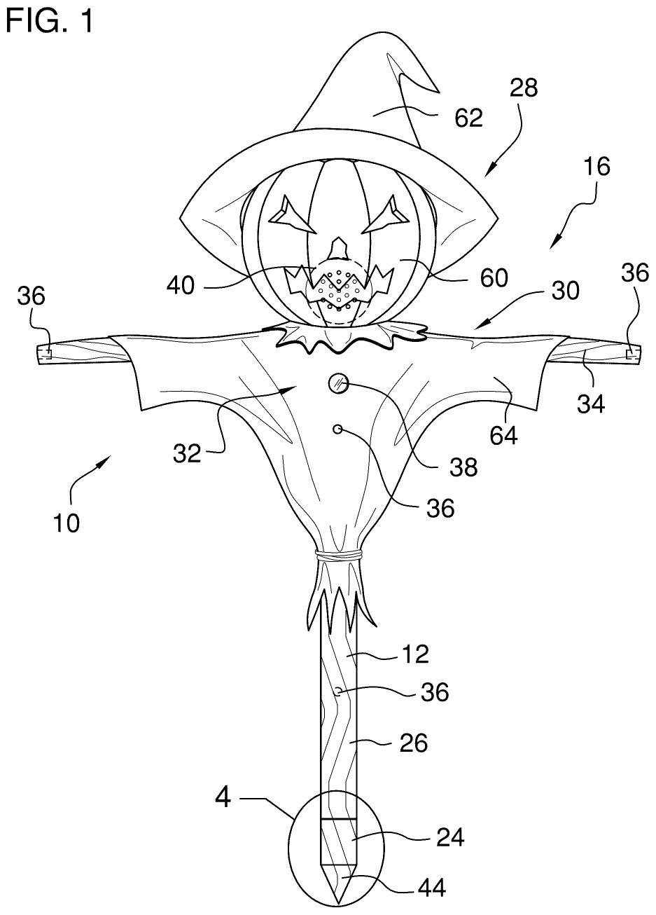

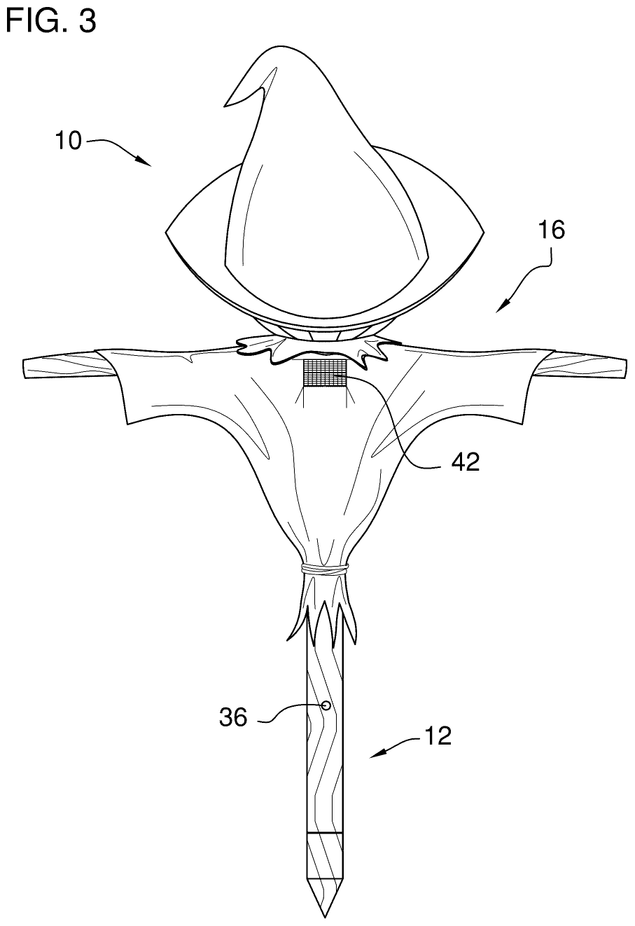

With reference now to the drawings, and in particular to FIGS. 1 through 6 thereof, a new motorized scarecrow embodying the principles and concepts of an embodiment of the disclosure and generally designated by the reference numeral 10 will be described.

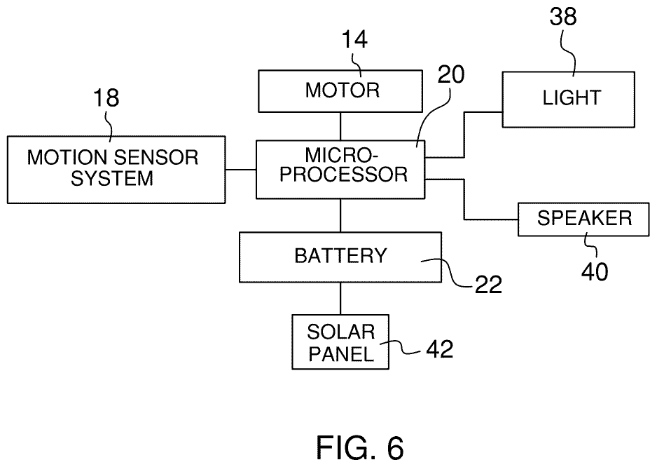

As best illustrated in FIGS. 1 through 6, the motorized scarecrow 10 generally comprises a post 12, a motor 14 positioned in the post 12, a body 16, a motion sensor system 18, a microprocessor 20, and a battery 22. The post 12 includes a base portion 24 and a support portion 26 that is rotatable with respect to the base portion 24. The motor 14 is connected to the support portion 26 to rotate the support portion 26 with respect to the base portion 24. The body 16 is mounted on the support portion 26 of the post 12. The body 16 includes a head portion 28 and a shoulder portion 30 designed to represent a human being. The motion sensor system 18 is attached to the body 16. The motion sensor system 18 is designed to detect motion and a location of a being, such as a human or animal. The microprocessor 20 is positioned in the body 16. The microprocessor 20 is connected to the motor 14 and the motion sensor system 18. The microprocessor 20 is designed to activate the motor 14 upon detection movement of the being by the motion sensor system 18 to rotate the support portion 26 of the post 12. The microprocessor 20 is designed to deactivate the motor 14 upon the body 16 is oriented with a front portion 32 of the body 16 facing toward the detected location of the being. The battery 22 is positioned in the body 16. The battery 22 is connected to the motor 14, the motion sensor system 18, and the microprocessor 20, as represented schematically in FIG. 6.

In the exemplary embodiment in FIG. 1, the head portion 28 is a jack-o-lantern face 60 with a hat 62, though this is merely an example, and virtually any decorative elements could be used. The shoulder portion 30 is made of a crosspiece 34 with a shirt 64 hanging from the crosspiece 34 to complete the representation or impression of the human being. Again, this is merely an example, and various decorative designs and other decorative elements could be used, as is well known in the traditional designs of scarecrows.

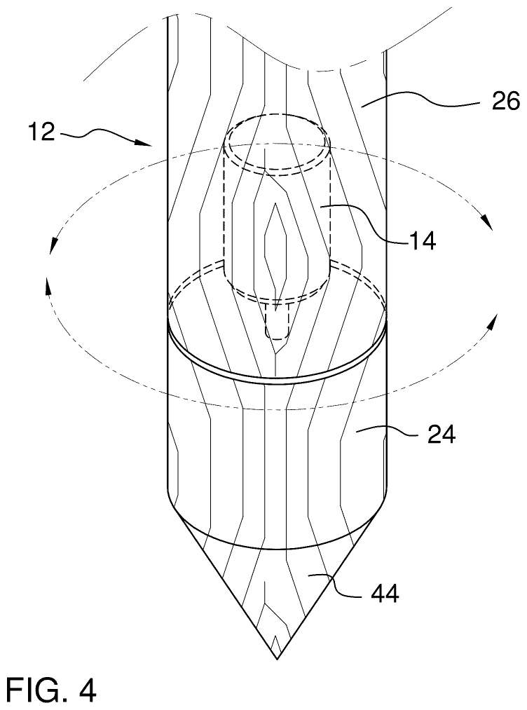

The motion sensor system 18 is designed to detect motion and the location of the being over a 360-degree field of detection. The motor 14 is designed to rotate the support portion 26 over a 360-degree range of movement, as shown in FIG. 4. As shown in FIGS. 1 through 3, the motion sensor system 18 includes a plurality of motion sensor units 36 attached to different areas of the body 16 to permit detection of motion of the being over the 360-degree field of detection. In the exemplary embodiment, motion sensor units 36 are mounted on the body 16, the post 12, and the crosspiece 34.

In the exemplary embodiment in FIG. 1, the motorized scarecrow 10 further includes a light 38 that is attached to the body 16. The light 38 is connected to the microprocessor 20. The microprocessor 20 is designed to activate the light 38 upon detection of the being by the motion sensor system 18. In one possible embodiment, the microprocessor 20 is designed to operate the light 38 intermittently to produce a flashing or strobe effect.

In the exemplary embodiment in FIG. 1, the motorized scarecrow 10 further includes a speaker 40 that is attached to the body 16. The speaker 40 is connected to the microprocessor 20. The microprocessor 20 is designed to activate the speaker 40 upon detection of the being by the motion sensor system 18. The microprocessor 20 is designed to store audio files including noises and messages to be emitted by the speaker 40.

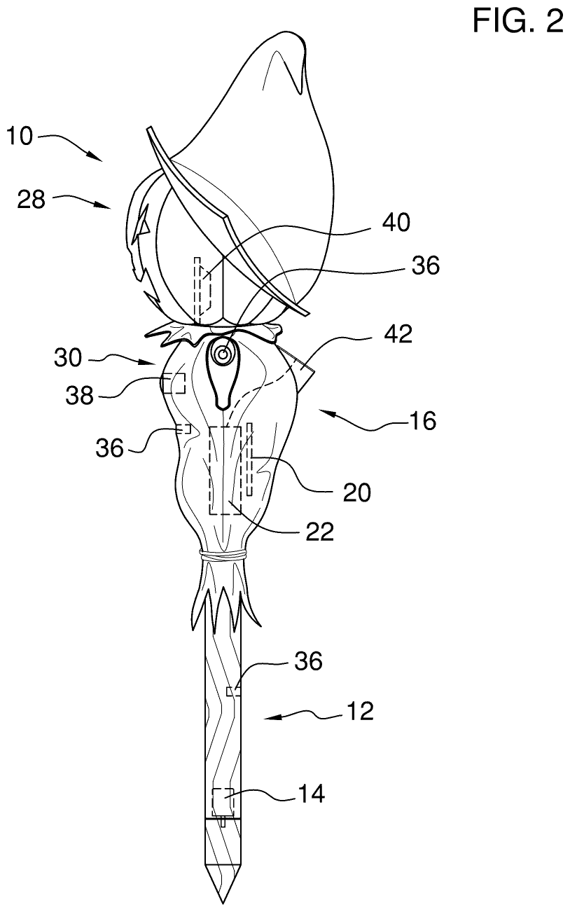

In the exemplary embodiment in FIG. 2, the motorized scarecrow 10 further includes a solar panel 42 attached to the body 16. The solar panel 42 is connected to the battery 22 to recharge the battery 22.

In the exemplary embodiment in FIG. 1, the base portion 24 includes a pointed tip 44 designed to permit insertion of the base portion 24 into ground. FIG. 4 shows a close-up view of the pointed tip 44, as well as the motor 14 inside the support portion 26 of the post 12. In one possible embodiment, the base portion 24 could be enlarged with a flat bottom to form a pedestal-style support. The base portion 24 could also have a screw thread or a spiral design to facilitate insertion into the ground. As shown in FIG. 4 and elsewhere, the post 12 has a wood grain appearance, but could be made from metal, plastic, wood, or other suitable material for outdoor use.

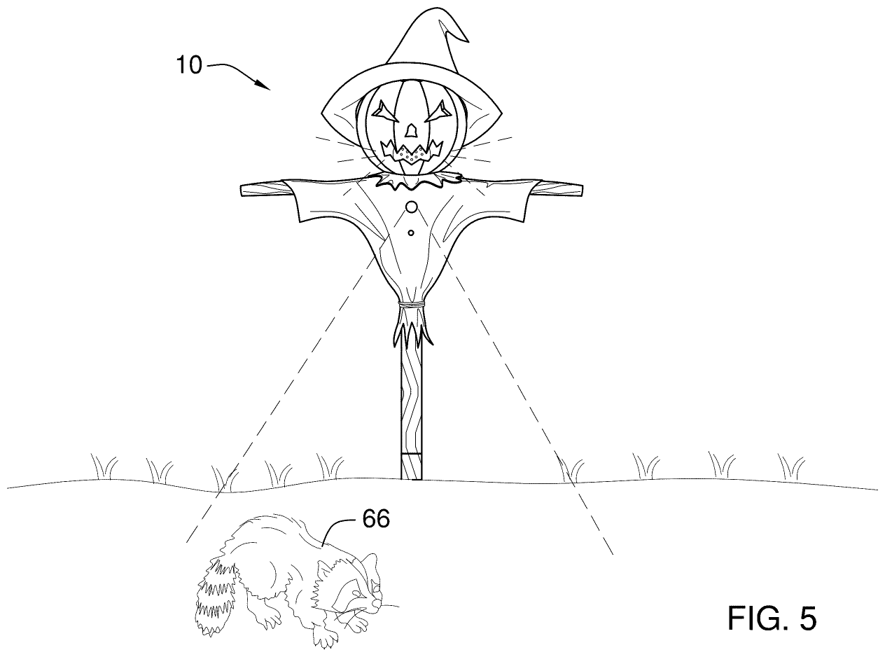

In use, the motorized scarecrow 10 functions as a normal scarecrow would to frighten a being, such as an animal 66 as shown in FIG. 5. However, the motorized scarecrow 10 goes beyond traditional scarecrows by being able to rotate to orient the body 16 toward the being, as well as emit lights and sound to further frighten the being. The microprocessor 20 can be programmed to execute pre-set functions, or could include an interface to allow a user to program functions, such as operating time and types of movement, light, and sounds.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A motorized scarecrow comprising:
a post, said post including a base portion and a support portion being rotatable with respect to said base portion;
a motor being disposed in said post, said motor being connected to said support portion to rotate said support portion with respect to said base portion;
a body being mounted on said support portion of said post, said body including a head portion and a shoulder portion configured to represent a human being;
a motion sensor system being attached to said body, said motion sensor system being configured to detect motion and a location of a being;
a microprocessor being disposed in said body, said microprocessor being connected to said motor and said motion sensor system, said microprocessor being configured to activate said motor upon detection movement of the being by said motion sensor system to rotate said support portion of said post, said microprocessor being configured to deactivate said motor upon said body being oriented with a front portion of said body facing toward the detected location of the being; and
a battery being disposed in said body, said battery being connected to said motor, said motion sensor system, and said microprocessor.

2. The motorized scarecrow of claim 1, further comprising a light being attached to said body, said light being connected to said microprocessor, said microprocessor being configured to activate said light upon detection of the being by said motion sensor system.

3. The motorized scarecrow of claim 2, wherein said microprocessor is configured to operate said light intermittently to produce a flashing or strobe effect.

4. The motorized scarecrow of claim 1, further comprising a speaker being attached to said body, said speaker being connected to said microprocessor, said microprocessor being configured to activate said speaker upon detection of the being by said motion sensor system.

5. The motorized scarecrow of claim 4, wherein said microprocessor is configured to store audio files including noises and messages to be emitted by said speaker.

6. The motorized scarecrow of claim 1, further comprising a solar panel attached to said body, said solar panel being connected to said battery to recharge said battery.

7. The motorized scarecrow of claim 1, wherein said base portion includes a pointed tip configured to permit insertion of said base portion into ground.

8. The motorized scarecrow of claim 1, wherein said motion sensor system is configured to detect motion and the location of the being over a 360-degree field of detection, and said motor is configured to rotate said support portion over a 360-degree range of movement.

9. The motorized scarecrow of claim 1, wherein said motion sensor system includes a plurality of motion sensor units attached to different areas of said body to permit detection of motion of the being over said 360-degree field of detection.

10. A motorized scarecrow comprising:
a post, said post including a base portion and a support portion being rotatable with respect to said base portion;
a motor being disposed in said post, said motor being connected to said support portion to rotate said support portion with respect to said base portion;
a body being mounted on said support portion of said post, said body including a head portion and a shoulder portion configured to represent a human being;
a motion sensor system being attached to said body, said motion sensor system being configured to detect motion and a location of a being;
a microprocessor being disposed in said body, said microprocessor being connected to said motor and said motion sensor system, said microprocessor being configured to activate said motor upon detection movement of the being by said motion sensor system to rotate said support portion of said post, said microprocessor being configured to deactivate said motor upon said body being oriented with a front portion of said body facing toward the detected location of the being, wherein:
a battery being disposed in said body, said battery being connected to said motor, said motion sensor system, and said microprocessor;
a light being attached to said body, said light being connected to said microprocessor, said microprocessor being configured to activate said light upon detection of the being by said motion sensor system, said microprocessor being configured to operate said light intermittently to produce a flashing or strobe effect; and
a speaker being attached to said body, said speaker being connected to said microprocessor, said microprocessor being configured to activate said speaker upon detection of the being by said motion sensor system, said microprocessor being configured to store audio files including noises and messages to be emitted by said speaker.

11. The motorized scarecrow of claim 10, wherein said motion sensor system is configured to detect motion and the location of the being over a 360-degree field of detection, and said motor is configured to rotate said support portion over a 360-degree range of movement.

12. The motorized scarecrow of claim 11, wherein said motion sensor system includes a plurality of motion sensor units attached to different areas of said body to permit detection of motion of the being over said 360-degree field of detection.

13. The motorized scarecrow of claim 12, further comprising a solar panel attached to said body, said solar panel being connected to said battery to recharge said battery.

14. The motorized scarecrow of claim 13, wherein said base portion includes a pointed tip configured to permit insertion of said base portion into ground.

15. (canceled)
